(19) United States
(12) Patent Application Publication
(10) Pub. No.: US 2010/0058463 A1
(43) Pub. Date: Mar. 4, 2010

(54) METHOD OF EXCHANGING DATA BETWEEN TWO ELECTRONIC ENTITIES

(75) Inventor: Marc BERTIN, La Celle Les Bordes (FR)

Correspondence Address: YOUNG & THOMPSON, 209 Madison Street, Suite 500, Alexandria, VA, 22314, US

(73) Assignee: OBERTHUR TECHNOLOGIES, Levallois-Perret (FR)

(21) Appl. No.: 12/550,117

(22) Filed: Aug. 28, 2009

(30) Foreign Application Priority Data
Aug. 28, 2008 (FR) 0855770

(51) Int. Cl. G06F 21/22; G06F 9/445; G06F 1/26

(52) U.S. Cl. 726/17; 717/178; 713/310

(57) ABSTRACT

A method of exchanging data between a first electronic entity and a second electronic entity includes the following steps:
initiating (E400) communication between the first electronic entity and the second electronic entity subsequently to bringing the first and second electronic entities closer together;
in consequence of the initiation, transmitting (E415) an application from the second electronic entity to the first electronic entity;
storing (E416) the application in the first electronic entity.

A method for exchange of data between two electronic entities.

In the framework of the exchange of data between two electronic entities (which data can be represented in the form of electrical signals in these electronic entities, for example in memories carried by these electronic entities), it has been proposed in particular to implement short range communication (also known as near field communication (NFC)), as described in patent application WO 2007/121 791. The expression short range generally refers to a range of less than 1 m, for example a range of the order of 50 cm, or even 20 cm.

The RFID technology is frequently used to provide such short range communication, and consists in providing a remote power feed by means of a reader to an electronic circuit (for example carried by a “tag”, but possibly also by any other object, for example a mobile telephone) which can then communicate with the reader and transmit to it data intended in particular (in the most standard uses of this technology) to identify the product or the person bearing the tag.

Although the limitation of the interaction between the reader and the electronic circuit to the near field generated by the reader (which is in practice a magnetic field) might initially seem problematic, it is to the contrary seen as an advantage of this technology, because communication is initiated by bringing the electronic circuit and the reader close together and thus, typically, stems from an intentional action on the part of the bearer of the electronic circuit.

The patent application WO 2006/115 842 describes a use of this type, for example.

At present, each electronic circuit designed to use the RFID technology is designed with a particular object (i.e. with a view to a particular service) and in that context holds only data relating to the service concerned (for example the code associated with the user's account in the aforementioned document WO 2006/115 842). If the electronic circuit is carried by a telephone, the data relating to the service is thus stored in a memory of the telephone, for example. This solution is lacking in flexibility, however, and for example obliges a user to obtain in advance a plurality of tags each configured to work with each service that they wish to enjoy. Generally speaking it is impossible to access services for which the electronic circuit is not configured.

To improve on this state of affairs, the invention proposes a method of exchanging data between a first electronic entity and a second electronic entity, characterized by the following steps:
initiating communication between the first electronic entity and the second electronic entity subsequently to bringing the first and second electronic entities closer together;
in consequence of said initiation, verifying the presence in a memory of the first electronic entity of an application relating to the second electronic entity;
in the case of negative verification, launching a process for loading said application into the first electronic entity.

Thus, if necessary, an installation process is launched automatically (while being possibly monitored by the user), which installation process installs an application that enables access to functions associated with the second electronic entity (the reader in the examples given hereinafter), even though there is originally no provision for this in the first electronic entity (mobile object).

For example, the step of initiating communication in practice comprises the following steps:
remote power feeding of the first electronic entity by the second electronic entity;
sending a communication set-up message from the first electronic entity to the second electronic entity.

In a first embodiment, the verification step comprises the following steps:
the second electronic entity sending the first electronic entity a command designating said application;
searching said memory for said application.

In a second embodiment, the verification step comprises the following steps:
the first electronic entity sending a list of applications present in said memory;
the second electronic entity determining the presence of said application in said list.

The step of launching the loading process can comprise the following steps:
displaying on the first electronic entity information indicating said launching;
awaiting validation;
loading said application in the case of validation.

The step of launching the loading process can also comprise a step of the first electronic entity preparing a request for loading of said application, in which case execution of the preparation step can be conditional on receiving authorization of a user.

The above two solutions enable the user to retain control over installation of the application despite the automatic launching of that installation.

In one embodiment that can be envisaged, said loading can be effected by sending said application from the second electronic entity to the first electronic entity.

This transmission can use short range communication means of the electronic entity.

Alternatively, the transmission of the application could nevertheless be obtained by communication between high throughput wireless (i.e. contactless) interfaces of the first and second electronic entities, such as WUSB or BLUETOOTH interfaces. These interfaces are generally separate from the short range, here NFC, interface.

The application is thus exchanged quickly between the electronic entities.

In another embodiment that can be envisaged, said loading is effected by connecting to a remote server. There can then be a step of the first electronic entity receiving from the second electronic entity remote server connection parameters.

The can also be envisaged in this context a step of the first electronic entity receiving from the second electronic entity authentication information intended for the remote server.

In one particularly practical solution, the connection to the remote server can use communication means of the first electronic entity.

In another embodiment, of particular benefit if the first electronic entity has no means of connection to the remote server, there can be provided a step of connecting the first electronic entity to a personal computer adapted to make the connection to the remote server.

The application obtained by the loading process is used for example during exchanges between the first electronic entity and the second electronic entity.

In this context, the following steps can be implemented:
the first electronic entity executing the application in order to determine a response;
the first electronic entity sending the response to the second electronic entity.

The first electronic entity is a portable (or pocket) electronic entity, for example, such as a mobile telephone or a portable information medium (of the USB key type) and the communication is short range wireless communication.

Other features and advantages of the invention will become more apparent in the light of the following description, given with reference to the appended drawings, in which:

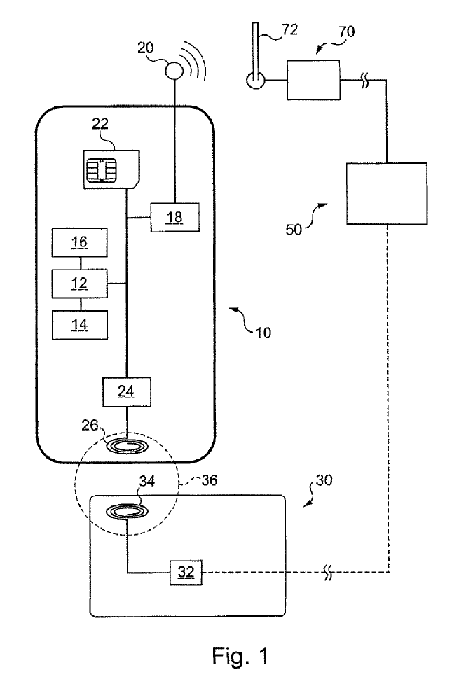

FIG. 1 represents one possible context for implementation of the invention;

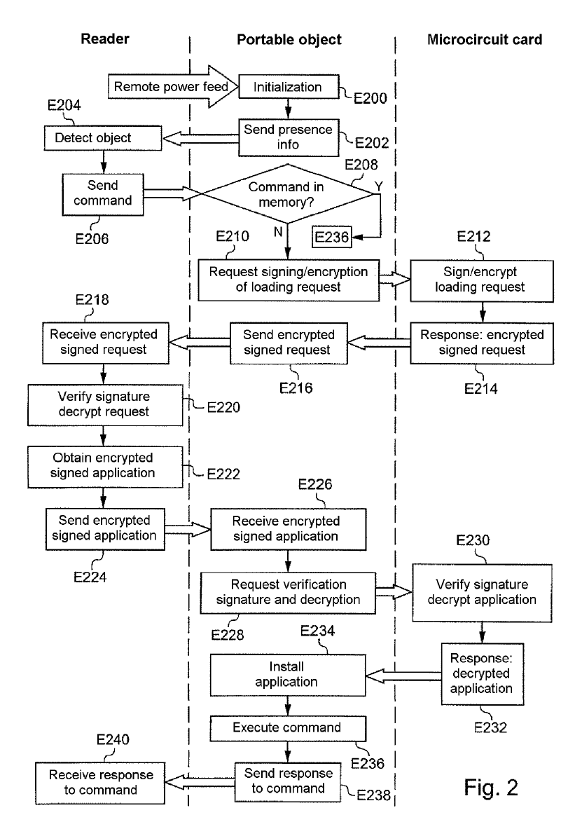

FIG. 2 represents the execution of exchanges between the devices of FIG. 1 in a first embodiment of the invention;

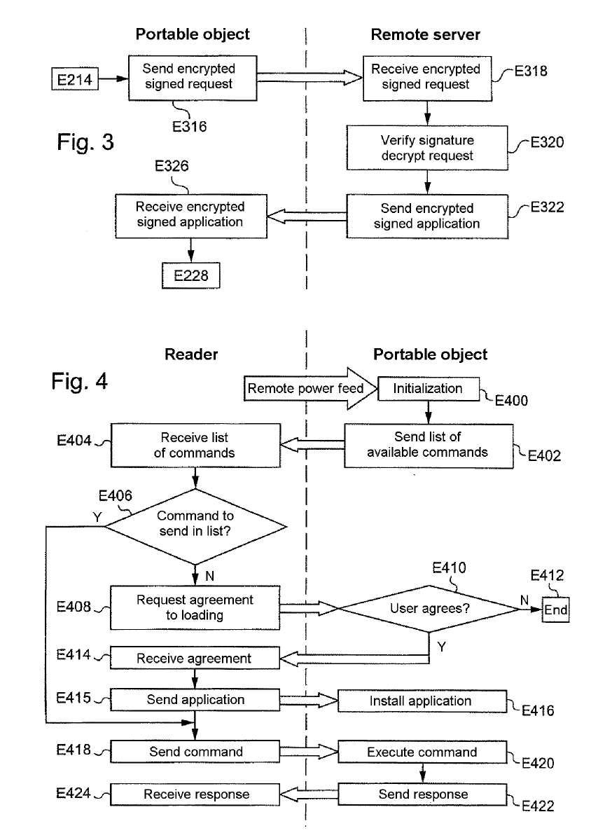

FIG. 3 represents the execution of such exchanges in a second embodiment of the invention;

FIG. 4 represents the execution of such exchanges in a third embodiment of the invention;

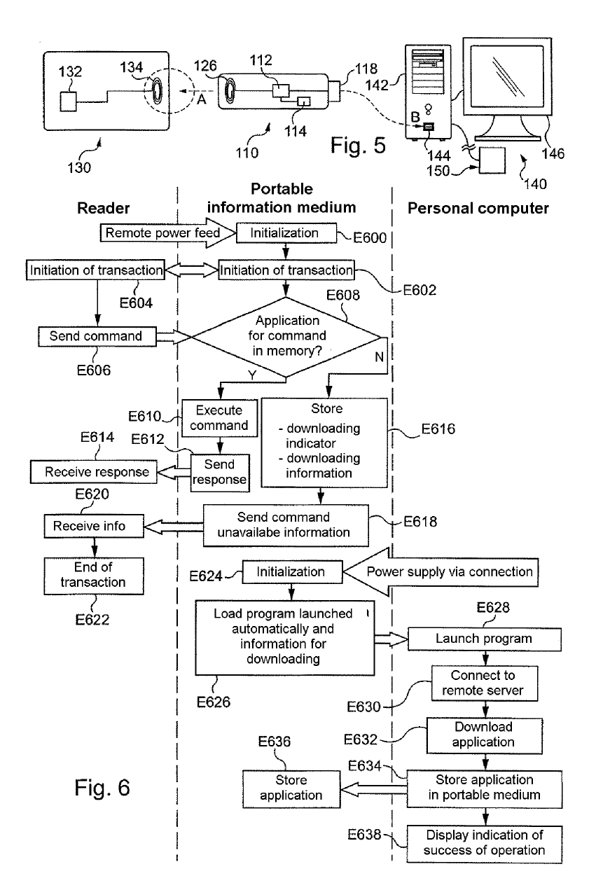

FIG. 5 represents another context that can be envisaged for the implementation of the invention;

FIG. 6 represents an example of a method used in the context of FIG. 5.

FIG. 1 represents one example of a context in which the invention can be implemented.

Such a context includes in particular a portable object 10 (here a mobile telephone) and a reader 30.

The mobile telephone 10 and the reader 30 can exchange data via short range communication (for example NFC) means.

Those short range communication means include in particular an NFC module 24 cooperating (for example via a bus) with a microprocessor 12 of the mobile telephone and connected to an NFC antenna 26 also carried by the mobile telephone 10.

The reader 30 also includes an antenna 34 through which a current flows under the control of a control module 32 so as to generate a magnetic field 36 for supplying power to and communicating with objects situated in the vicinity of the reader 30 (generally in an area extending to less than one meter from the reader, for example to less than approximately 20 cm therefrom, the range being in practice from 1 cm to 10 cm with the technologies widely used at present).

As already indicated, the mobile telephone 10 includes a microprocessor 12 adapted to manage the various functions of the mobile telephone 10, in particular the interface with the user of the mobile telephone 10 (for example by means of a keypad and a screen, not shown). To this end in particular, a read-only memory 16 and a random-access memory 14 are associated with the microprocessor 12.

The read-only memory 16 stores in particular sequences of instructions intended to be executed by the microprocessor 12 in order to implement methods within the mobile telephone 10, in particular the methods proposed by the invention and described hereinafter.

The random-access memory 14 stores parameters or instructions necessary for the execution of the methods mentioned above.

Note further that, as well as or instead of one of the memories 14, 16, there can be provided a non-volatile rewritable memory for storing some of the data or instructions mentioned above.

The mobile telephone 10 also includes a microcircuit card reader module receiving (removably) a microcircuit card, the combination 22 formed by these two elements being represented diagrammatically in FIG. 1. The card reader module 22 is connected to the microprocessor 12, for example via the bus mentioned above.

The mobile telephone 10 finally includes a cellular telecommunications module 18 adapted to exchange data (which can represent the voice of a speaker, for example, but can equally be data or instructions sent to the microprocessor 12, for example) with a base station 70 of a cellular telephone network (in particular via an antenna with which the mobile telephone 10 is equipped and an antenna 72 of the base station).

A server 50 stores in particular applications intended for the mobile telephone 10 in the framework of its exchanges with the reader 30, as explained hereinafter. In the embodiment considered here, this server 50 is connected to the reader 30 or to the base station 70 (and in practice possibly to both these elements), for example by means of cable connections, possibly via the Internet.

There is described now with reference to FIG. 2 a first example of a method for exchanging data between the various elements described hereinabove in accordance with the teachings of the invention.

This method is used after the portable object 10 (here a mobile telephone, as already indicated) is brought near the reader 30 (here to within less than 20 cm of it, as indicated above), which normally corresponds to the user of the mobile telephone 10 wishing to use functions associated with this reader 30.

Because the telephone 10 and the reader 30 have been brought close together, the telephone 10 (and in particular its NFC antenna 26) enters the magnetic field 36 generated by the reader 30, which instigates a remote power feed to the module 24 and consequently its initialization in the step E200.

Note that the NFC module 24 with which the mobile telephone 10 is equipped can alternatively be supplied with power by the mobile telephone 10 (in which case there is no remote power feed by the reader 30) but can be reinitialized (step E200) as soon as the antenna 26 enters the electromagnetic field 26 of the reader 30.

The NFC module 24 then initiates communication with the reader 30, for example by sending it in the step E202 information indicating its presence in the field 36 of the reader 30. Communication can be initiated as described in the ISO 14443 standard, for example.

Thus in the step E204 the reader 30 detects the portable object 10 (which here is a mobile telephone) and consequently sends a command to it in the step E206. The command is an element of the implementation of the function that the user is seeking when they bring the telephone 10 close to the reader 30, as mentioned above. It is an APDU command according to the ISO 7816 standard, for example. Alternatively, the command need not itself participate in the function that the user is seeking but instead include as a parameter the application associated with the function that the user is seeking.

The telephone receives the command via the NFC link: the command passes through the NFC module 24 to the microprocessor 12 that is its destination.

Then in the step E208 the microprocessor 12 verifies if the code (for example the executable or interpretable code, i.e. the application) for executing this command (or part of this command, for example a subroutine) is stored in one of the memories 14, 16 (or possibly in a memory of the microcircuit card 22). The code (i.e. the application) is a series of independent instructions (in practice at least three instructions), stored in executable or interpretable form, for example, or even in the form of a source program to be compiled: these applications are for example formulated in the languages Javacard, Javascript, Java, assembler, C++.

This verification is effected, for example, by consultation of a table that contains, for each command that can be envisaged, an indicator of the presence of the application associated with that command in the memory of the mobile telephone 10 and, in the event that the application is present, its storage address.

It is equally possible in the embodiments described hereinafter to provide for storing in the same table, but this time with no application in the memory, data that is useful for obtaining the application (for example information to the effect that the application must be obtained from the reader 30 itself as in the present embodiment, or the coordinates of the server 50—for example a number usable by the cellular telephone system or an http address—with a view to downloading, as in the second embodiment described hereinafter with reference to FIG. 3).

If so, the microprocessor executes the application in order to execute the command as described hereinafter in the step E236.

If not, the microprocessor 12 prepares an application loading request and to this end first requests the microcircuit card module 22 to sign and encrypt this loading request (step E210).

The loading request includes a description of the command (such as a command number), for example, and possibly parameters such as elements describing the technical specifications of the mobile telephone 10 and possibly the http address of the server 50.

As already indicated, the loading request is sent to the microcircuit card 22 for signing and encryption (step E212) using a key stored in the microcircuit card and the microcircuit card 22 then sends the encrypted and signed request back to the microprocessor 12 (step E214).

The sending and/or encryption of the request can be conditional upon verification (here by the card 22) of the presence of a right by the microcircuit card 22 and/or by an authorization (possibly with authentication) of the user of the mobile telephone 10, for example by selection of an item from a menu or pressing a particular key, or by entering and verifying a personal code (of PIN (Personal Identification Number) type).

Alternatively, the user can be requested to provide such authorization at the time of loading or installing the application.

Alternatively the operations of encryption and/or authentication of the user can be carried out by the mobile telephone 10 (instead of the microcircuit card 22).

The encrypted and signed request can then be sent over the NFC link (i.e. in practice via the NFC module 24) to the reader 30, which thus receives the encrypted and signed request in the step E218.

The reader 30 and primarily its control module 32 can thus verify the signature in order to be sure of the identity of the object 10 (or of the microcircuit card 22 or the bearer of the object, and thus where appropriate verify authorization of the latter to receive the application) and decrypt the request, for example by means of a key associated with the private key stored in the microcircuit card 22 of the portable object 10.

Following the above operations, the control module 32 of the reader 30 can proceed to process the decrypted request and to this end obtains a copy of the application to be transmitted, for example by reading a storage device associated with the reader 30 (such as a hard disk connected locally or integrated into the reader 30) or by means of a connection to the server 50 mentioned above and holding the application (in which case the connection between the reader 30 and the server 50 is preferably a secure connection, especially if the connection between the reader 30 and the server 50 uses at least in part a public network such as the Internet). Note that in this latter case the reader 30 sending the encrypted and signed request directly to the server 50 can be envisaged instead and that verification of the signature and decryption are effected by the server 50.

In the embodiment described here, the copy of the application obtained by the reader 30 in the step E222 is moreover a version that has been encrypted and signed, for example using a private key held by the publisher of the application.

The encrypted and signed application is sent from the reader 30 to the mobile telephone 10 via the NFC link in the step E224 and the microprocessor 12 thus receives the encrypted and signed application via the NFC module 24 in the step E226. As already indicated, the application could instead be exchanged via other interfaces of the telephone 10 and the reader 30, for example high throughput wireless interfaces.

Then in the step E228 the microprocessor 12 sends the version of the application received to the microcircuit card module 22 for verification of the signature and decryption of the latter version.

In the step E230 the microcircuit card module 22 then proceeds to verify the signature (by means of the public key associated with the private key of the publisher of the application, and decrypts the version of the application received from the reader 30 by means of a secret key, the aforementioned keys being obtained by the microcircuit card 22 by connecting to a server, for example, via the Internet, for example, and stored in a memory of the microcircuit card 22 or the mobile telephone 10, for example a nonvolatile memory).

In the step E232 the microcircuit card module 22 sends back the decrypted application (when the signature has been verified, of course; if not, the application received is not executed).

Thus the microprocessor 12 receives the application from the microcircuit card module 22 and stores it in the random-access memory 14 (or alternatively in the microcircuit card 22), which enables it to be installed in the step E234, possibly with other, associated operations.

Alternatively the application can be installed (and thus in particular stored) in a nonvolatile memory of the mobile telephone. In this case a list of the applications installed in this way can be kept, for example in the telephone, with the date of the last use of each of them, for example in order to delete the application least recently when the memory space allocated is full and a new installation is required.

Thus the microprocessor 12 can execute the command requested by the reader 30 in the step E236 using the application that has just been received by the method described above (“no” response in step E208) or that is already stored in the mobile telephone 10 (“yes” response in step E208).

As indicated above, the command (or the application designated as a parameter in the command in the variant already referred to above) is part of the implementation of a function required by the user of the mobile telephone and in this context defines a particular exchange protocol between the reader 30 and the mobile telephone 10, for example.

In this context, the mobile telephone 10 sends back a response following on from execution of the command (or the application designated by it) to the reader 30 (step E238), which response the reader receives in the step E240.

There is now described with reference to FIG. 3 a second example of exchange of data between the devices of FIG. 1 in accordance with the teachings of the invention.

This second example is a variant of the first example just described with reference to FIG. 2 and their common parts corresponding to the steps E200 to E214 and E228 to E240 will therefore not be described again.

In this second example, when communication between the mobile telephone 10 and the reader 30 has been initiated and the mobile telephone 10 has determined that it is not holding the code (i.e. the application) necessary to execute a command requested by the reader 30 and that loading of that application into the mobile telephone is required (as in the steps E200 to E214 described above), the mobile telephone 10 sends the server 50 an encrypted and signed request (prepared by the steps E210 to E214 described above) via the cellular telephone network (including in particular the base station 70) on which the mobile telephone 10 can send data (and in particular the aforementioned encrypted and signed request), thanks in particular to its cellular telecommunication module 18.

Communication between the mobile telephone 10 (to be more precise the telecommunication module 18) and the remote server 50 uses a GPRS type link, for example, in particular between the mobile telephone 10 and the base station 70 and possibly in part the Internet between the base station 70 and the remote server 50 (generally via a gateway enabling the base station 70 to access the Internet). Alternatively, the data could be transmitted between the mobile telephone 10 and the base station 70 via a wireless data network (for example of WiFi type).

Note that the data (or parameters) necessary for the connection to the remote server 50 are stored in a table, for example, as indicated above. Alternatively, this data could be transmitted by the reader 30 during preliminary exchanges between the reader 30 and the mobile telephone 10, for example at the request of the mobile telephone 10 when it has determined that the command is not in its memory.

In the step E318 the server 50 receives the encrypted and signed request and proceeds in the step E320 to verify that signature and to decrypt the request using methods analogous to those of the step E220 in the first embodiment described with reference to FIG. 2.

Once the request has been decrypted, the server 50 can process it and respond to it by sending the requested application, preferably in encrypted and signed form, for example via the communication channel already used to transmit the request, namely here via the base station 70 and the cellular telephone system associated with the communication module 18.

Thus the mobile telephone 10 receives the encrypted and signed application in the step E326 so that the process can continue in exactly the same way as for the first embodiment as described above with reference to step E228 to E240. Note here that, during exchanges with the server 50 that has just been described, the mobile telephone 10 can send waiting messages (where appropriate including a report as to the progress of the process for obtaining the application) to the reader 30 (where applicable in response to prompts from the reader 30).

FIG. 3 represents a third example of the method of exchanging data between the elements from FIG. 1.

As in the above examples, communication between the portable object 10 and the reader 30 is engaged by virtue of the remote power feeding of the short range communication means of the portable object 10 as a result of moving the latter closer to the reader 30, which leads to initialization of communication between the portable object 10 and the reader 30 in the step E400.

In the example described here, the portable object then sends a list of commands available in the portable object (step E402) via these short range communication means. Note that the portable object 10 here sends the list of commands available without any prompting by the reader 30.

Alternatively, the list of commands available in the portable object 10 could be sent to the reader 30 only at the request of the reader 30, for example by the reader 30 sending a request for communication of the list or if the portable object 10 receives a command from the reader 30.

In the step E404 the reader 30 receives the list of commands or applications available in the portable object 10.

The reader 30 can then itself determine if a command or application intended for the portable object 10 is contained in this list of the commands available (step E406) or if an application necessary for execution of the command is contained in the list.

If so, the reader 30 can send the command to the portable object 10 (in the step E418 described hereinafter).

If not, the loading into the portable object 10 of the application corresponding to the command required by the reader 30 constitutes a preliminary step to sending this command and the reader 30 launches a process of loading the application from the step E408 onward, as described hereinafter.

Note that in a variant that can be envisaged the determination of the availability of the command in the portable object 10 could be effected by sending a request to the portable object, verifying the presence of the associated application in the portable object 10 as in the previous embodiments, and the portable object 10 sending the reader 30 information indicating the availability or non-availability of the command in the portable object 10.

As indicated above, if it is determined that loading of the application associated with a command is necessary before execution thereof, there follows the step E408 in which in the present embodiment the reader 30 sends the portable object 10 a request for agreement to such loading.

The portable object 10 receives this request for agreement and requests the agreement of the user, for example, as shown in the step E410 (typically by displaying a corresponding message for the attention of the user and awaiting a response from the user via a keypad of the portable object 10).

If the user refuses loading (“no” response in the step E410), communication between the reader 30 and the portable object 10 is terminated, for example, because a command from one to the other cannot be executed (step E412).

On the other hand, if the user agrees to loading (“yes” response in the step E410), for example by pressing a predetermined real or virtual key (menu) and/or by entering a personal code, the portable object 10 sends back to the reader 30 information indicating that agreement (step E414).

Note that requesting the user's agreement in the manner described above is one possible embodiment, but that other variants can be envisaged: in particular, the portable object 10 could agree to loading as a function of a parameter stored in the portable object 10 and indicating that such loading is authorized.

Alternatively the user's agreement could be requested before installing the application, i.e. immediately after the step E416 described below.

After reception of the agreement for loading in the step E414, the reader 30 proceeds to send the application associated with the command in the step E415, which application the reader 30 holds beforehand, for example on a local hard disk (or in any other storage means, such as a memory, for example) or is obtained via a connection (possibly a secure connection) to the remote server 50, as indicated above with reference to the first embodiment.

The application is then received by the portable object 10 in the step E416 and installed therein (i.e. primarily stored in a memory of the portable object 10, typically the memory 14).

Once the application has been sent in the step E415, and possibly after a time delay (or alternatively on reception of confirmation by the object 10 that the application has been installed), the reader can proceed to send the required command in the step E418.

The portable object 10 receives the command in the step E420 and executes it using the application in its memory (where appropriate because it was loaded in the step E415 as described above).

The result of executing this application is sent in the step E422 in the form of a response to the reader 30, which receive this information in the step E424.

Another possible implementation context for the invention is described now with reference to FIG. 5.

There is also provided in this other context a reader 130 comprising a processor 132 and short range communication (e.g. NFC) means 134.

A portable object 110 is also used, here a portable information medium, for example of the USB (Universal Serial Bus) type comprising a microprocessor 112 with which are associated a memory 114 (for example of EEPROM or Flash type) and short range communication (here also NFC type) means 126 and interface means 118 (here represented for reasons of simplification as a simple male connector of the interface means) adapted to set up communication between the microprocessor 112 and an external electronic entity designed to receive the aforementioned connector, this electronic entity typically being a personal computer (PC), as will be the case in the example described hereinafter.

The example described hereinafter further uses a personal computer 140 formed in particular of a central processor unit 142 (which in particular includes a microprocessor of the personal computer) provided with a female connector 144 (here of USB type) adapted to receive the male connector of the interface means 118 of the portable object 110. Note that there is described here the case of a connection by physical contact between the portable object 110 and the personal computer 140, but that this connection could alternatively be a wireless connection.

The personal computer 140 also includes a display screen 146 under the control of the central unit 142.

The personal computer 140 finally includes means for connection to a network, here the Internet network, enabling it in particular to exchange data with a remote server 150 in which are stored in particular applications used to execute the commands of the protocol used for exchanges between the reader 130 and the portable object 110 via the short range communication means.

FIG. 6 shows an example of the method conforming to the teachings of the invention used in the context of FIG. 5.

When a user brings the portable object 110 (here a USB key) close to the reader 130 (arrow A in FIG. 5), the short range communication means 126 of the portable object 110 enter the field of the reader, which enables remote power feeding of the USB key 110, which in particular leads to its initialization in the step E600.

A transaction between the portable object 110 and the reader 130 is then initiated (in step E604 in the reader and in step E602 in the portable object 110).

Once communication has been set up (and where applicable after preliminary exchanges between the reader 130 and the portable object 110), the reader 130 sends a command to the portable object 110 (step E606).

The portable object 110 receives this command and verifies in the step E608 if it has in the memory 114 an application for executing that command (step E608). In a variant already mentioned in connection with the first embodiment, the command can include by way of a parameter information designating the required application.

If so, the command is executed in the step E610 and a response to this command is sent, for example in the step E612, from the portable object 110 to the reader 130, which receives it in the step E614.

If not, in the step E608 the microprocessor 112 of the portable object 110 commands (in step E616) storage in the memory 114 on the one hand of an indicator of the necessity to download the missing application and on the other hand information useful for that downloading, for example the address for connection to a remote server holding the application, information designating the command and/or the application, and authentication information.

This information is for example communicated by the reader 130 to the portable object 110 at the same time as the command in the step E606 described above. The authentication information is for example generated by the reader 130, possibly using a cryptographic key stored in the processor 132 (or an associated memory), and by cryptographic means associated with the processor 132.

Furthermore, in the step E618 the portable object 110 sends information indicating that the command is unavailable the reader 130, which receives this information in the step E620 and consequently terminates the transaction in the step E622.

The user, on discovering that the transaction has not terminated correctly (for example because the function that was the reason for bringing the portable object 110 near the reader 130 has not been executed, or alternatively thanks to the display of an indication that the transaction has not terminated correctly on the reader 130 when the latter receives the information indicating that the command is not available in the step E620), connects the portable object 110 to the central unit 142 of the personal computer 140 by inserting the male connector 118 into the female connector 144 (arrow A), which powers up the portable object 110 and results in its initialization in the step E624.

The memory 114 of the portable object 110 contains an automatic loading and launching program. On connection of the portable object 110 to the central unit 142, this program is transferred to the central unit 142 in the step E626 and executed by the latter in the step E628.

This program calls on the information used for downloading mentioned above, which information is either loaded into the central unit 142 at the same time as the program itself or read from the central unit 142 in the memory 114 of the portable object 110, in order to set up a connection with the remote server 150 identified in this downloading information (step E630).

If necessary, the central unit 142 then sends the remote server 150 the information designating the command and/or the program and the authentication information, in order for the remote server 150 to be able to determine which application it must send and to verify by means of the authentication information that it is authorized to send it.

If downloading is authorized by the remote server 150, the central unit downloads the application in the step E632 and commands its storage in the memory 114 of the portable object 110 (step E634).

The personal computer can then for example display an indication of the success of the downloading operation by means of the screen 146 in the step E638.

Thus the portable object 110 stores in the step E636 the application used to execute the command requested in the step E606.

The user can then bring the portable object 110 close to the reader 130 (or another reader of the same type), which will initiate a process identical to that described above (starting from the step E600), except that verification will be possible in the step E608 and will lead to execution of the command in the step E610 and sending a response in the step E612, as described above.

The previous examples are only possible embodiments of the invention, which is not limited to them. In particular, a variant can be envisaged in which the mobile telephone equipped with the NFC module functions as the reader. Moreover, the features and variants of the various embodiments described hereinabove can be combined.

1. Method of exchanging data between a first electronic entity (10) and a second electronic entity (30), characterized by the following steps:
initiating communication between the first electronic entity (10) and the second electronic entity (30) subsequently to bringing the first and second electronic entities (10, 30) closer together;
in consequence of said initiation, transmitting (E224;
E415) an application from the second electronic entity (30) to the first electronic entity (10);
storing (E234; E416) said application in the first electronic entity (10).

2. Method according to claim 1 of exchanging data, wherein said step of initiating communication comprises the following steps:
remote power feeding of the first electronic entity (10) by the second electronic entity (30);
sending a communication set-up message from the first electronic entity (10) to the second electronic entity (30).

3. Method according to claim 1 of exchanging data, including a step, executed in consequence of the initiation and prior to the transmission of the application, of verifying (E208; E406) the presence of said application in a memory of the first electronic entity.

4. Method according to claim 3 of exchanging data, wherein the verification step comprises the following steps:
the second electronic entity (30) sending (E206) the first electronic entity (10) a command designating said application;
searching (E208) a memory of the first electronic entity for said application.

5. Method according to claim 3 of exchanging data, wherein said verification step comprises the following steps:
the first electronic entity (10) sending (E402) a list of applications present in a memory of the first electronic entity;
the second electronic entity (30) determining (E406) the presence of said application in said list.

6. Method according to claim 1 of exchanging data, comprising the following steps executed in consequence of the initiation and prior to the transmission of the application:
displaying on the first electronic entity information indicating transmission;
awaiting validation (E410);
transmitting (E415) the application in the case of validation.

7. Method according to claim 1 of exchanging data, comprising a step of the first electronic entity preparing a request for loading of said application.

8. Method according to claim 7 of exchanging data, wherein the execution of the preparation step is conditional on receiving authorization of a user.

9. Method according to claim 1 of exchanging data, comprising the following steps:
the first electronic entity (10) executing (E236; E420) the application in order to determine a response;
the first electronic entity (10) sending (E238; E422) the response to the second electronic entity (30).

10. Method according to claim 9 of exchanging data, wherein the transmission (E224; E415) of the application and the sending (E238; E422) of the response are effected by communication between short range communication means respectively equipping the first and second electronic entities.

11. Method according to claim 1 of exchanging data, wherein the transmission (E224; E415) of the application is effected by communication between high throughput wireless interfaces respectively equipping the first and second electronic entities.

12. Method according to claim 1 of exchanging data, wherein the application relates to the second electronic entity.

13. Method according to claim 1 of exchanging data, wherein the first electronic entity is a portable electronic entity.

14. Method according to claim 1 of exchanging data, wherein communication is short range wireless communication.

15. Method according to claim 2 of exchanging data, including a step, executed in consequence of the initiation and prior to the transmission of the application, of verifying (E208; E406) the presence of said application in a memory of the first electronic entity.

16. Method according to claim 15 of exchanging data, wherein said verification step comprises the following steps:
the first electronic entity (10) sending (E402) a list of applications present in a memory of the first electronic entity;
the second electronic entity (30) determining (E406) the presence of said application in said list.
